(19) United States
(12) Patent Application Publication
(10) Pub. No.: US 2025/0334493 A1
(43) Pub. Date: Oct. 30, 2025

(54) AUTODILUTION SYSTEM HAVING CALIBRATED FLOW PATH BETWEEN TWO VALVES

(71) Applicant: Elemental Scientific, Inc., Omaha, NE (US)

(72) Inventors: Austin Schultz, Omaha, NE (US); Caleb Gilmore, Omaha, NE (US); Alejandro De Anda, Omaha, NE (US); Brad Prucha, Omaha, NE (US); Kevin Wiederin, Omaha, NE (US); Daniel R. Wiederin, Omaha, NE (US)

(21) Appl. No.: 19/189,540

(22) Filed: Apr. 25, 2025

Related U.S. Application Data
(60) Provisional application No. 63/639,972, filed on Apr. 29, 2024.

(51) Int. Cl. G01N 1/38

(52) U.S. Cl. CPC G01N 1/38

(57) ABSTRACT

Sample preparation systems and methods for inline autodilution of fluid samples are described. A system embodiment includes, but is not limited to, a probe valve fluidically coupled with a sample probe to receive a fluid sample; a nebulizer valve; a plurality of fluid lines fluidically coupling the probe valve with the nebulizer valve and including (i) a sample line and (ii) a dilution line into which a sample to be diluted is directed; a pump system; and a controller configured to access sample information associated with the fluid sample to determine a dilution factor for the fluid sample, the controller configured to change the configuration of the probe valve or the nebulizer valve based on the dilution factor assigned to the fluid sample to direct the fluid sample into the dilution line prior to the sample line for fluid samples having a dilution factor greater than one.

### CROSS-REFERENCE TO RELATED APPLICATIONS

The present application claims the benefit of 35 U.S.C. § 119(e) of U.S. Provisional Application Ser. No. 63/639,972, filed Apr. 29, 2024, and titled “AUTODILUTION SYSTEM HAVING CALIBRATED FLOW PATH BETWEEN TWO VALVES.” U.S. Provisional Application Ser. No. 63/639,972 is herein incorporated by reference in its entirety.

### BACKGROUND

Inductively Coupled Plasma (ICP) spectrometry is an analysis technique commonly used for the determination of trace element concentrations and isotope ratios in liquid samples. ICP spectrometry employs electromagnetically generated partially ionized argon plasma which reaches a temperature of approximately 7,000K. When a sample is introduced to the plasma, the high temperature causes sample atoms to become ionized or emit light. Since each chemical element produces a characteristic mass or emission spectrum, measuring the spectra of the emitted mass or light allows the determination of the elemental composition of the original sample.

Sample introduction systems may be employed to introduce the liquid samples into the ICP spectrometry instrumentation (e.g., an Inductively Coupled Plasma Mass Spectrometer (ICP/ICP-MS), an Inductively Coupled Plasma Atomic Emission Spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP spectrometry instrumentation. Prior or during transportation of the aliquot to the nebulizer, the sample aliquot may be mixed with hydride generation reagents and fed into a hydride gas/liquid separator that channels hydride and/or sample gas into the nebulizer. The aerosol generated by the nebulizer is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Sample preparation systems and methods for inline autodilution of fluid samples are described. A system embodiment includes, but is not limited to, a probe valve fluidically coupled with a sample probe to receive a fluid sample from the sample probe; a nebulizer valve configured to fluidically couple with a nebulizer of an analysis system; a plurality of fluid lines fluidically coupling the probe valve with the nebulizer valve, the plurality of fluid lines including (i) a sample line having a known and predefined internal volume from the probe valve to the nebulizer valve and (ii) a dilution line, into which a sample to be diluted is directed prior to transfer to the sample line; a pump system configured to transfer fluids through the probe valve, the nebulizer valve, and the plurality of fluid lines; and a controller operably coupled with each of the probe valve and the nebulizer valve, the controller configured to access sample information associated with the fluid sample to determine a dilution factor for the fluid sample, the controller further configured to change the configuration of one or more of the probe valve or the nebulizer valve based on a dilution factor assigned to the fluid sample to direct, via action of the pump system, the fluid sample into the dilution line prior to the sample line for fluid samples having a dilution factor greater than one.

In an aspect, a method embodiment includes, but is not limited to, drawing a fluid sample from a sample vessel into a sample probe of an autodilution system, the autodilution system including: a probe valve fluidically coupled with the sample probe to receive the fluid sample from the sample probe, a nebulizer valve configured to fluidically couple with a nebulizer of an analysis system, a plurality of fluid lines fluidically coupling the probe valve with the nebulizer valve, the plurality of fluid lines including (i) a sample line having a known and predefined internal volume from the probe valve to the nebulizer valve and (ii) a dilution line, into which a sample to be diluted is directed prior to transfer to the sample line, a pump system configured to transfer fluids through the probe valve, the nebulizer valve, and the plurality of fluid lines, and a controller operably coupled with each of the probe valve and the nebulizer valve, the controller configured to access sample information associated with the fluid sample to determine a dilution factor for the fluid sample, the controller further configured to change the configuration of one or more of the probe valve or the nebulizer valve based on a dilution factor assigned to the fluid sample to direct, via action of the pump system, the fluid sample into dilution line prior to the sample line for fluid samples having a dilution factor greater than one; transferring, via the pump system, the fluid sample from the sample probe, through the probe valve, and into the sample line for the dilution factor being one; and transferring, via the pump system, the fluid sample from the sample probe, through the probe valve, and into the dilution line for the dilution factor being greater than one.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a schematic of an autodilution system to prepare samples for analysis, in accordance with an embodiment of this disclosure.

FIG. 2A is a diagram of the autodilution system of FIG. 1 transferring a fluid sample from a sample probe, through a valve of the autosampler system, and into a sample line to a valve of the analysis system, in accordance with an embodiment of this disclosure.

FIG. 2B is a diagram of the autodilution system of FIG. 2A transferring the fluid sample from the sample line to a nebulizer for analysis by the analysis system, in accordance with an embodiment of this disclosure.

FIG. 3A is a diagram of the autodilution system of FIG. 1 transferring a fluid sample from a sample probe, through a valve of the autosampler system, and into a dilution line to a valve of the analysis system, in accordance with an embodiment of this disclosure.

FIG. 3B is a diagram of the autodilution system of FIG. 3A diluting and transferring the fluid sample from the dilution line through the valve of the analysis system and through a sample line to the valve of the autosampler system providing a diluted sample, in accordance with an embodiment of this disclosure.

FIG. 3C is a diagram of the autodilution system of FIG. 3B transferring the diluted sample from the sample line to a nebulizer for analysis by the analysis system, in accordance with an embodiment of this disclosure.

FIG. 4A is a diagram of a valve and pump configuration of the autodilution system of FIG. 1, in accordance with an embodiment of this disclosure.

FIG. 4B is a diagram of a valve and pump configuration of the autodilution system of FIG. 1, in accordance with an embodiment of this disclosure.

FIG. 5 is a diagram of a valve and pump configuration of the autodilution system of FIG. 4B, shown in an undiluted vacuum load configuration for direct analysis of a fluid sample without dilution, in accordance with an embodiment of this disclosure.

FIG. 6 is a diagram of a valve and pump configuration of the autodilution system of FIG. 4B, shown in an undiluted syringe pump load configuration for direct analysis of a fluid sample without dilution, in accordance with an embodiment of this disclosure.

FIG. 7 is a diagram of a valve and pump configuration of the autodilution system of FIG. 4B, shown in an undiluted sample inject configuration injecting the undiluted fluid sample into a nebulizer for analysis by the analysis system, in accordance with an embodiment of this disclosure.

FIG. 8A is a diagram of a valve and pump configuration of the autodilution system of FIG. 4B, shown in a diluted vacuum load configuration for analysis of a fluid sample with a dilution factor exceeding 1, in accordance with an embodiment of this disclosure.

FIG. 8B is a diagram of a valve and pump configuration of the autodilution system of FIG. 4A, shown in a diluted vacuum load configuration for analysis of a fluid sample with a dilution factor exceeding 1, in accordance with an embodiment of this disclosure.

FIG. 9 is a diagram of a valve and pump configuration of the autodilution system of FIG. 4B, shown in a diluted syringe pump load configuration for analysis of a fluid sample with a dilution factor exceeding 1, in accordance with an embodiment of this disclosure.

FIG. 10A is a diagram of a valve and pump configuration of the autodilution system of FIG. 4B, shown in a dilution configuration for diluting and transferring the fluid sample from the valve of the analysis system through a sample line to the valve of the autosampler system providing a diluted sample, in accordance with an embodiment of this disclosure.

FIG. 10B is a diagram of a valve and pump configuration of the autodilution system of FIG. 4A, shown diluting a fluid sample while backflushing the sample probe with diluted sample, in accordance with an embodiment of this disclosure.

FIG. 10C is a diagram of a valve and pump configuration of the autodilution system of FIG. 4A, shown diluting a fluid sample while transferring a portion of the diluted sample through a restriction line of constant volume that includes an exit end open to atmospheric pressure, in accordance with an embodiment of this disclosure.

FIG. 11A is a diagram of a valve and pump configuration of the autodilution system of FIG. 4B, shown in a dilution inject configuration for transferring the fluid sample from the sample line into a nebulizer for analysis by the analysis system, in accordance with an embodiment of this disclosure.

FIG. 11B is a diagram of a valve and pump configuration of the autodilution system of FIG. 4A, shown in a dilution inject configuration to permit a syringe pump to initially transfer diluted sample to the nebulizer valve at a flow rate greater than the analytical flow rate of the analysis system for a first time, then subsequently matching the transfer rate of the diluted sample to the analytical flow rate, in accordance with an embodiment of this disclosure.

FIG. 12A is a diagram of a valve and pump configuration of the autodilution system of FIG. 4A, shown in a syringe line bubble introduction configuration to fill a portion of the syringe pump lines with air to prepare to dilute a sample with a first bubble between the fluid sample and the diluent and with a second bubble between the diluted sample and the dilution carrier fluid, in in accordance with an embodiment of this disclosure.

FIG. 12B is a diagram of a valve and pump configuration of the autodilution system of FIG. 4A, shown in a sample inject bubble introduction configuration to introduce a bubble between the diluted sample and the analytical carrier fluid during injection of the sample into the nebulizer of the analysis system, in in accordance with an embodiment of this disclosure.

FIG. 13A is a dataset corresponding to analysis of a fluid sample transferred through the sample line of the autodilution system of FIG. 1 via a carrier fluid with direct contact between the carrier fluid and an end of the fluid sample in the sample line.

FIG. 13B is a dataset corresponding to analysis of a fluid sample transferred through the sample line of the autodilution system of FIG. 1 via a carrier fluid with a gas bubble interposed between the end of the fluid sample and the carrier fluid, preventing direct contact between the carrier fluid and the fluid sample in the sample line.

FIG. 14 is a side view of a filter probe for filtering particulates from the autodilution system of FIG. 1, in accordance with an embodiment of this disclosure.

FIG. 15A is bottom view of a filter of the filter probe of FIG. 14, in accordance with an embodiment of this disclosure.

FIG. 15B is top view of the filter of the filter probe of FIG. 14, in accordance with an embodiment of this disclosure.

FIG. 15C is partial isometric cross-sectional view of the filter of the filter probe of FIG. 14, in accordance with an embodiment of this disclosure.

FIG. 16A is a schematic illustration of the filter probe of FIG. 14, shown filtering particulates from a fluid sample.

FIG. 16B is a schematic illustration of the filter probe of FIG. 16A, shown backflushing the filtered particulates from the filter probe.

FIG. 17 an isometric view a probe valve module of the autodilution system of FIG. 1, shown including a display and a sensor secured to the module housing, in accordance with an embodiment of this disclosure.

### DETAILED DESCRIPTION

### Overview

Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, pharmaceutical processing, etc.), the tolerances for impurities can be very strict, for example, on the order of fractions of parts per billion. In order to accurately measure trace elemental compositions for highly concentrated samples (e.g., metal ores, metallurgical compositions, etc.), the samples to be measured often require dilution for analysis by ICP spectrometry instrumentation (an Inductively Coupled Plasma Mass Spectrometer (ICP/ICP-MS), an Inductively Coupled Plasma Atomic Emission Spectrometer (ICP-AES), or the like)). For instance, if a sample is too concentrated, the sample could saturate the cones of the ICP spectrometry instrumentation, carry over undesirable background between samples, or ruin the instrumentation. However, obtaining accurate dilution factors can be difficult to achieve, particularly where manual techniques often involve relatively large volumes of liquids (e.g., 50 mL or more), delicate pipets or volumetric flasks, instrumentation requiring frequent certification, substantial time requirements, or the like.

Moreover, many automated sampling and dilution techniques include steps that can add seconds or minutes to the preparation time utilized to prepare a sample for analysis. For laboratories that process hundreds or thousands of samples daily, even small amounts of added preparation time for a single sample can reduce the overall throughput of the laboratory when those small amounts of time are amplified through the whole production run of samples. For example, sampling techniques can direct a sample from a transfer line into a separate loop before subsequently removing the sample from the loop and introducing a diluent to the sample to provide a diluted sample. However, introducing the sample to a separate loop from the transfer line takes time for the pump or vacuum source to draw or push the sample into the loop in order to fill the loop. For common sample volumes, such a sampling technique can add 20 to 30 seconds or more to a sample preparation time, costing a laboratory hours of time for that step alone over the course of processing hundreds of samples.

Accordingly, the present disclosure is directed, at least in part, to systems and methods for inline dilution of a sample or direct analysis of an undiluted sample by capturing a known quantity of the sample in a fluid line between a probe valve and a nebulizer valve. The systems and methods include a plurality of fluid lines between the probe valve and the nebulizer valve, where a first fluid line is a sample line used to capture the known quantity of sample, and a second fluid line is a diluent line used to direct sample to the nebulizer valve for subsequent transfer, capture, and dilution into the sample line for dilution according to a predetermined dilution factor. Following dilution, a precise amount of the diluted sample is captured in the sample line between the nebulizer valve and the probe valve and transferred from the sample line to a nebulizer of an analysis system. The systems and methods can isolate a known quantity of sample in a rapid manner, such as by capturing the sample in the sample line without previously transferring the sample into a holding loop at the analysis system. Such rapid sample collection and dilution reduces the time utilized to prepare samples for analysis, providing significant throughput benefits for laboratories that process large amounts of samples, while providing accurate, automated inline dilution of samples. The rapid sample collection and dilution also reduces reagent consumption and rinse fluid consumption by reducing the length of flow paths within the system utilized to prepare samples for analysis.

In various aspects, the systems and methods include a filter probe including a filter disposed between the probe and the fluid line into which the probe draws sample fluids to capture particulates that could potentially clog system components, such as fluid lines, valves, and the like. The systems and methods can backflush fluid through the filter (e.g., when the filter probe is positioned at a rinse station) to remove the captured particulates from the filter probe. In aspects, the filter of the filter probe is a single piece filter without substantive dead space encountered by fluid being backflushed through the filter to remove particulates caught by the filter. For instance, the filter can include an array of through-holes that are arranged entirely within a cross-sectional area of the fluid line coupled with the filter, which allows the system to backflush the entire filter in a single pass of fluid. For example, the through-holes are arranged entirely within the flow path of fluid passed through the fluid line coupled with the filter opposite the probe.

In various aspects, the systems and methods include sensors to sense that one or more of the sample line and the dilution line is filled with fluid (e.g., without substantive amounts of bubbles), or to note the presence of bubbles or voids within the fluid lines. For example, the systems and methods can position a first sensor adjacent the probe valve and a second sensor adjacent the nebulizer valve to measure the fluid flowing through the sample line, through one or more diluent lines, or combinations thereof. The sensors can be removably mounted to a housing of a sensor module, for example, by being detachable with a cable (e.g., retractable, coiled, spooled, etc.) to permit remote sensing of different fluid lines of the system.

In various aspects, the systems and methods facilitate introduction of carrier fluid between the probe valve and the nebulizer valve to maintain the passage of carrier flow to the analysis device of the analysis system during sample loading and sample dilution.

In various aspects, the systems and methods facilitate introduction of a gas between an end of the sample and the beginning of a carrier fluid to prevent contact between the sample and the carrier fluid during transfer of the sample to the analysis system. By preventing contact between the sample and the carrier fluid, the system prevents signal wash out of analytes present towards the end of the sample stream sent to the analysis system, where such analytes could otherwise be mixed with carrier fluid through internal fluid line fluid dynamics. In aspects, the systems and methods facilitate introduction of a gas between fluid flows during dilution of the sample to prevent contact between sample and rinse solution in the sample line, to prevent contact between sample and dilution carrier during dilution, or the like. For instance, bubble introduction techniques during dilution can be utilized for dilutions involving low dilution factors that require more sample held in the dilution line between the nebulizer valve and the probe valve to be used during dilution as compared to higher dilution factors that utilize far more diluent than sample, utilizing less sample held in the dilution line to prepare the diluted sample. For example, a gas bubble can be introduced between the fluid sample and the diluent, between the diluted sample and a dilution carrier fluid used to push the diluted sample from the dilution line into the sample line, or combinations thereof.

In various aspects, the systems and methods include display screens on the probe valve and the nebulizer valve to display information associated with operation of the valves, the sample preparation procedure, or the like, or combinations thereof. The display screens can be coordinated with the control system to display independent messages to each of the probe valve and the nebulizer valve to provide real-time system updates for each valve, while facilitating the option for different messages at each valve.

### Example Implementations

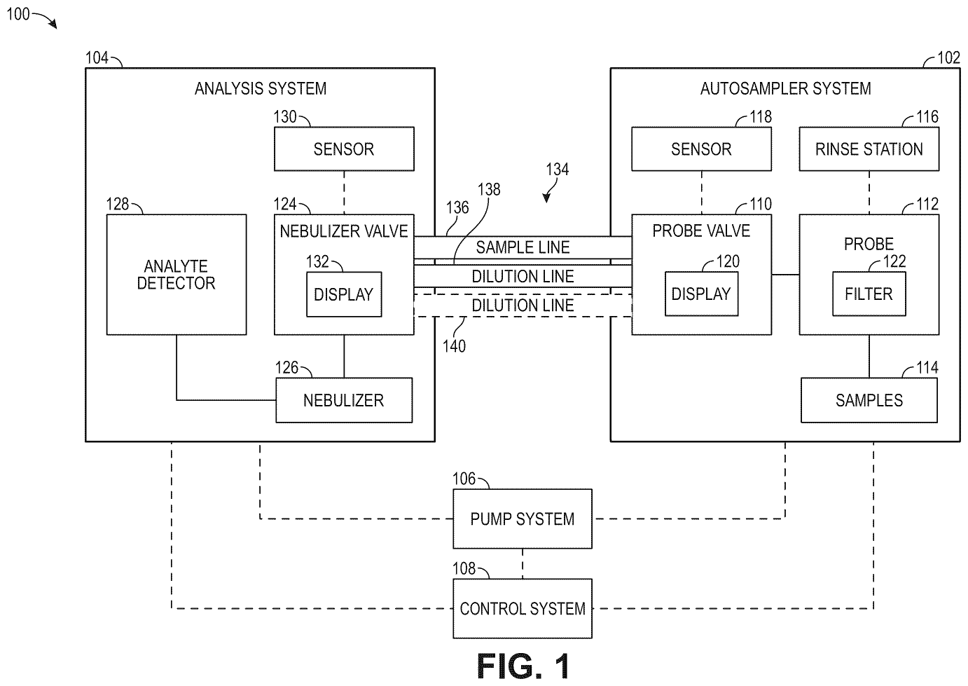

FIGS. 1 through 17 illustrate an autodilution system to prepare samples for analysis (“system 100”) in accordance with various embodiments of this disclosure, wherein the system 100 includes pump, valve, and control logic configurations that facilitate automatic, inline dilution of samples, standards, and other fluids for analytic analyses. Those skilled in the art will appreciate that the embodiments illustrated in the drawings and/or described herein may be modified or fully or partially combined to result in additional embodiments. Accordingly, the illustrated and described embodiments should be understood as explanatory and not as limitations of the present disclosure.

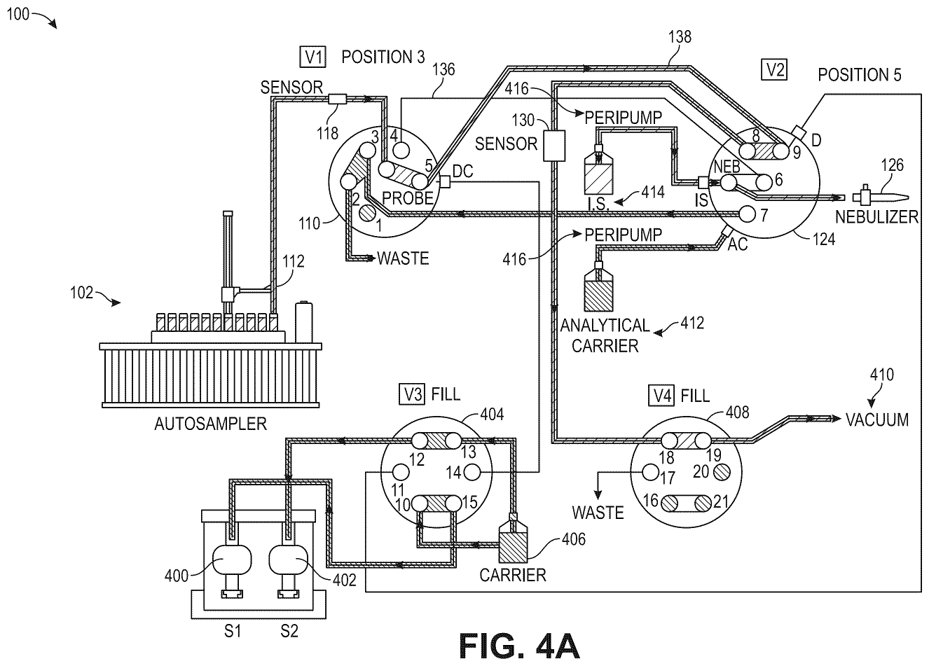

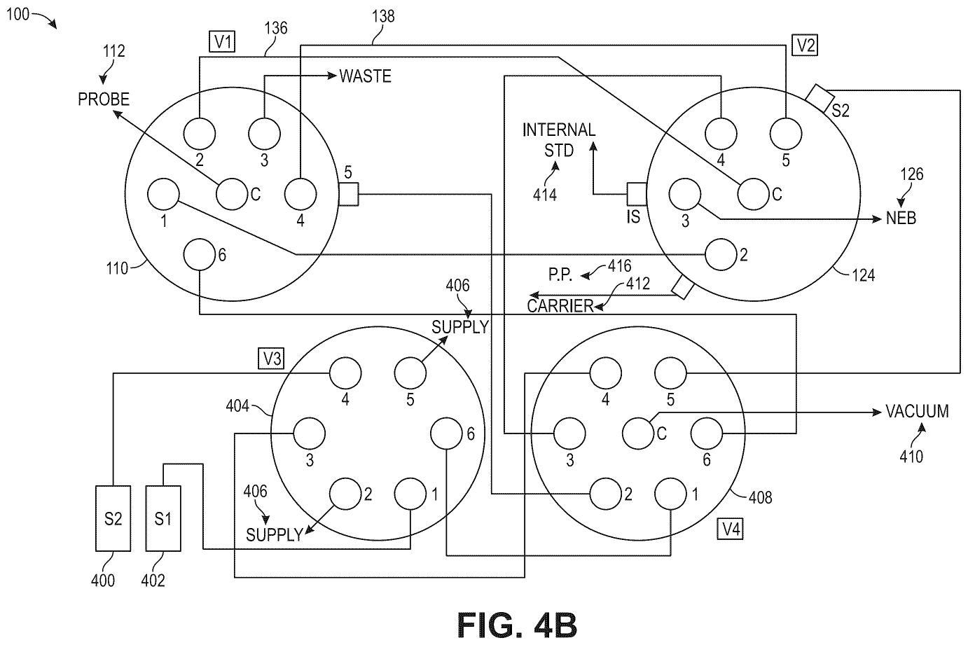

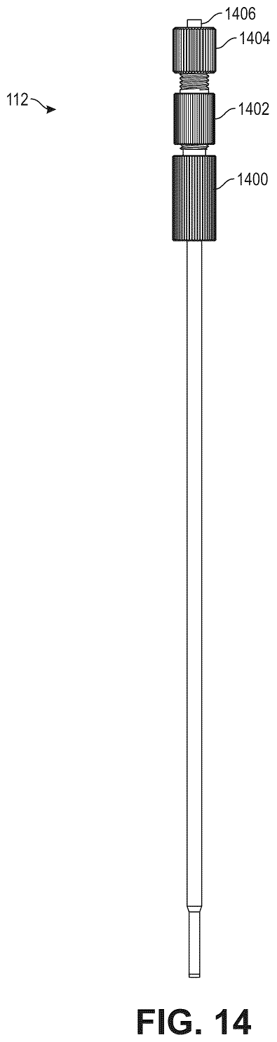

The system 100 is shown generally including an autosampler system 102, an analysis system 104, and a pump system 106, with a control system 108 communicatively coupling the components of the system 100 together. While the pump system 106 and the control system 108 are diagrammatically shown external to the autosampler system 102 and the analysis system 104, one or more portions of the pump system 106 and the control system 108 can be integrated with any other portion of the system 100 without departing from the scope of the present disclosure. The autosampler system 102 is configured to draw fluid samples for analysis by the analysis system 104 both with inline dilution and through direct transfer without dilution. The autosampler system 102 is shown generally including a probe valve 110, a probe 112, a sample station 114, a rinse station 116, and a sensor 118. The probe valve 110 is shown including a display 120 configured to display system messages associated with operation of the probe valve 110, the autosampler system 102, or other portions of the system 100. The probe 112 is shown including a filter 122 configured to filter particulates that could be present in the samples drawn into the probe 112 from the sample station 114. The sample station 114 can arrange fluid samples in a variety of sample vessels to make the samples held within the vessels available for access by the probe 112. For example, the sample vessels can include, but are not limited to, bottles, vials, flasks, wells of a microtiter plates, or the like, or combinations thereof. Implementations of the filter 122 are described further herein with respect to FIGS. 14 through 16B. In implementations, the probe valve 110 is a multiposition valve having a selector channel and one or more rotary channels configured to selectively, fluidically couple differing ports of the valve. Example probe valve 110 configurations are shown with respect to FIGS. 4A through 12B.

The analysis system 104 is configured to receive fluid samples transferred from the autosampler system 102 for analytic determination of the presence of analytes in the fluid samples (e.g., concentration of analytes, counts of analytes, or the like). For example, the analysis system 104 can include, but is not limited to, an inductively-coupled plasma analysis system (e.g., ICP-MS, ICP-AES, ICP-OES, etc.), an organic mass spectrometer, a gas chromatograph (GC), a liquid chromatograph (LC), a liquid chromatograph mass spectrometer (LC-MS), an ion chromatograph (IC), or another analytical instrument or technique to identify the presence and amount or concentration of one or more analytes of interest within the fluid sample. The analysis system 104 is shown generally including a nebulizer valve 124, a nebulizer 126, an analyte detector 128, and a sensor 130. The nebulizer valve 124 is shown including a display 132 configured to display system messages associated with operation of the nebulizer valve 124, the analysis system 104, or other portions of the system 100. In implementations, the nebulizer valve 124 is a multiposition valve having a selector channel and one or more rotary channels configured to selectively and fluidically couple differing ports of the valve. Example nebulizer valve 124 configurations are shown with respect to FIGS. 4A through 12B.

The system 100 includes a plurality of fluid lines 134 that fluidically couple the autosampler system 102 with the analysis system 104 for transfer of fluids between the respective systems. For instance, the system 100 is shown including a sample line 136 and at least one diluent line 138 fluidically coupled between the probe valve 110 and the nebulizer valve 124. One or more additional diluent lines 140 can be included in the system 100 to facilitate the preparation of additional sample dilutions. The sample line 136 has a known interior volume (e.g., the internal cross-sectional area and the length are known) to capture a specified volume of fluid sample in the sample line 136 between the probe valve 110 and the nebulizer valve 124. The specified volume is used in the determination of analyte concentration in the fluid sample when analyzed by the analyte detector 128 of the analysis system 104. For instance, one or more calibration curves of internal standard chemicals can be prepared through differing dilution factors of the standard for comparison to the counts of analytes measured by the analyte detector 128.

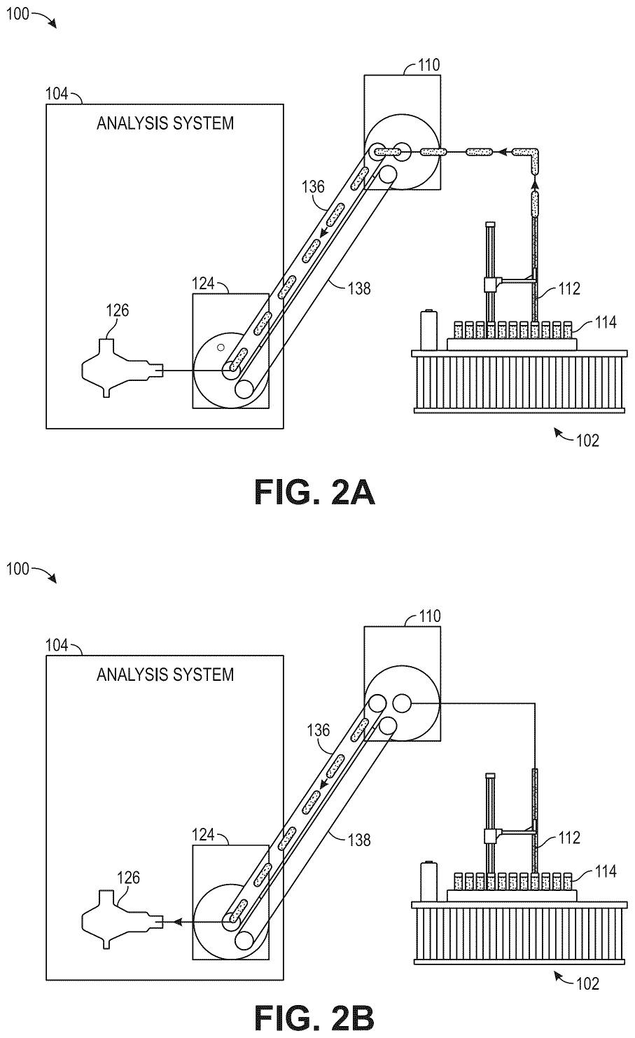

Since each of the sample line 136 and the dilution line 138 are fluidically coupled between the probe valve 110 and the nebulizer valve 124, the system 100 can operate to catch a precise amount of fluid within the sample line 136 without first directing the fluid to a sample loop that is fluidically coupled between two ports of the probe valve 110 or between two ports of the nebulizer valve 124. Example operations of the probe valve 110 and the nebulizer valve 124 to facilitate transfer and dilution of fluids through the system 100 are provided further herein with respect to FIGS. 2A through 12B.

The system 100 can also include other valves, pumps, vacuum sources, carrier fluid sources, internal standard sources, chemical sources, or the like, or combinations thereof to interact with other portions of the system 100 to facilitate operation of the features described further herein.

### Direct Sampling of Undiluted Sample

Referring to FIGS. 2A and 2B, the system 100 is shown in an example direct sample analysis procedure, where a sample is taken by the probe 112 of the autosampler system 102 for transfer to the nebulizer 126 of the analysis system 104 without dilution of the sample. For the direct sample analysis procedure, the probe 112 draws the sample from the sample station 114 and directs the sample into the probe valve 110. Alternatively or additionally, the probe 112 can handle a standard chemical solution for preparation of calibration curves. The probe valve 110 directs the sample into the sample line 136 for transfer to the nebulizer valve 124 (e.g., shown in FIG. 2A) to capture a known volume of fluid sample within the sample line 136. Excess sample can be directed from the nebulizer valve 124 to waste to ensure that the entire sample line 136 is filled with sample. If less than the entire sample line 136 contained sample, then the system 100 may not accurately determine the concentration of analytes of interest in the sample, since the calculations of the concentration would be based on the interior volume of the sample line 136. The system 100 then transfers the sample from the sample line 136 to the nebulizer 126 without dilution of the sample for analysis of the sample by the analysis system 104 (e.g., shown in FIG. 2B). For example, an analytical carrier fluid can be directed by the pump system 106 to push the sample held in the sample line 36 into the nebulizer 126. In implementations, an intervening bubble can be directed into the sample line 136 by the system 100 in front of the analytical carrier fluid to physically separate the sample from the analytical carrier fluid, as described further herein.

### Inline Sample Dilution

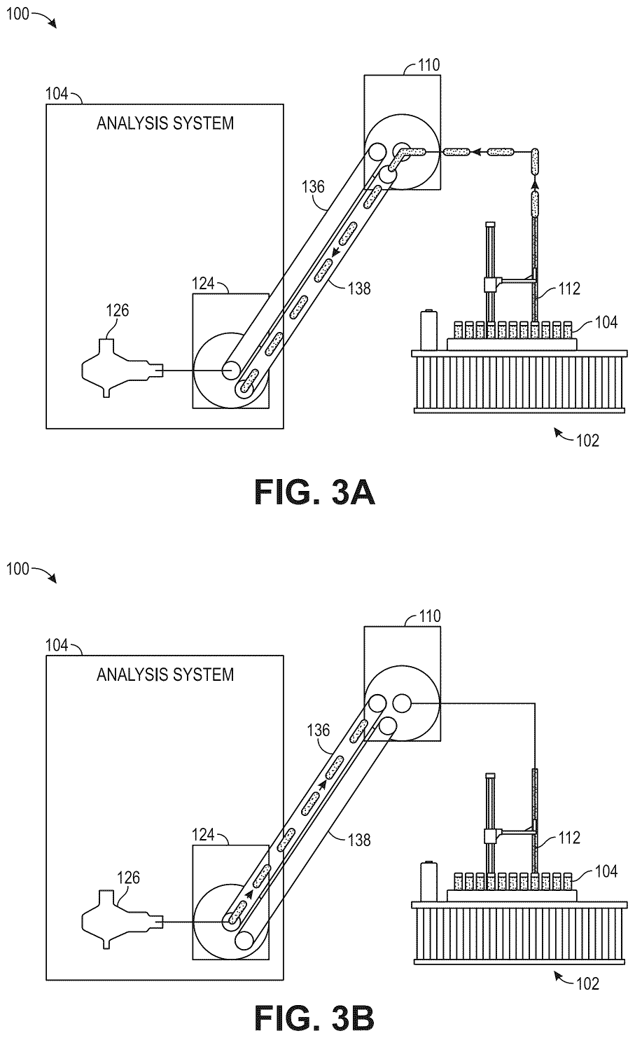

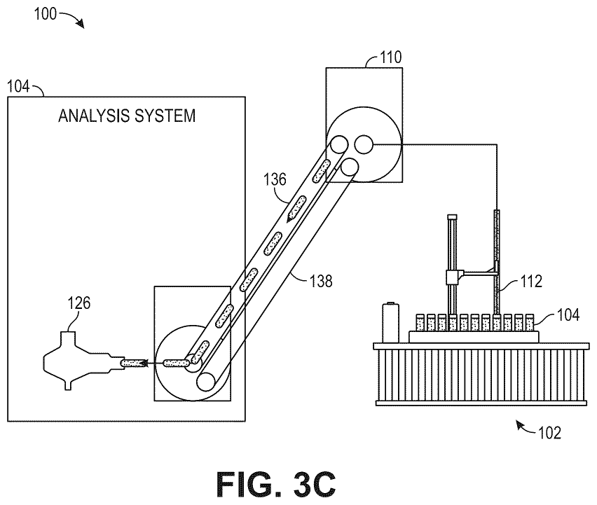

Referring to FIGS. 3A through 3C, the system 100 is shown in an example sample dilution procedure, where a sample is taken by the probe 112 of the autosampler system 102 for transfer to the nebulizer valve 124 for subsequent dilution of the sample prior to transfer to the nebulizer 126. For the sample dilution procedure, the probe 112 draws the sample from the sample station 114 and directs the sample into the probe valve 110. Alternatively or additionally, the probe 112 can handle a standard chemical solution for preparation of calibration curves. The probe valve 110 directs the sample into the dilution line 138 for transfer to the nebulizer valve 124 (e.g., shown in FIG. 3A). Alternatively or additionally, the sample could be transferred into one or more other dilution lines 140.

A diluent is then introduced to the sample (e.g., via operation of the pump system 106) to combine the diluent and the sample in the nebulizer valve 124 for transfer into the sample line 136 for transfer back to the probe valve 110 (e.g., shown in FIG. 3B). In implementations, syringe pumps are utilized to transfer each of the diluent and the sample into the sample line 136, where the relative pump speeds of the syringe pumps are controlled to obtain a desired dilution factor for the sample. Excess diluted sample can be directed from the probe valve 110 to waste to ensure that the entire sample line 136 is filled with a known volume of diluted sample. The system 100 then introduces a carrier fluid to the probe valve 110 to push the sample from sample line 136 through the nebulizer valve 124 and to the nebulizer 126 for analysis of the sample by the analysis system 104 (e.g., shown in FIG. 3C). In implementations, the system 100 introduces a gas bubble into the sample line 136 between an end of the diluted sample and a leading edge of the carrier fluid to prevent physical contact between the diluted sample and the carrier fluid through the presence of the buffer bubble, as described further herein.

### Example Valve, Fluid Line, and Pump Configurations

Referring to FIGS. 4A through 12B, example configurations of the valves, fluid lines, pumps, and other components of the system 100 are shown to facilitate operation of the various procedures described herein. For instance, FIGS. 4A and 4B illustrate two configurations of a general fluid line connection between the probe valve 110 (also shown as V1), the nebulizer valve 124 (also shown as V2), and valves, pumps, and fluid sources associated with the pump system 106, the autosampler system 102, the analysis system 104, or another portion of the system 100 or combinations thereof. For example, the system 100 is shown including a pair of syringe pumps (400, 402), a pump valve 404 fluidically coupled with a carrier fluid supply 406, a vacuum valve 408 fluidically coupled with a vacuum source 410. The system 100 can further include fluid handling systems for introducing an analytical carrier fluid 412 and an internal standard fluid 414, such as by including pumps (e.g., peristaltic pumps 416) to introduce the analytical carrier fluid 412 and an internal standard fluid 414 to the nebulizer valve 124 to push the sample from the sample line 136 or the add to the sample within the nebulizer valve 124, respectively.

### Undiluted Samples

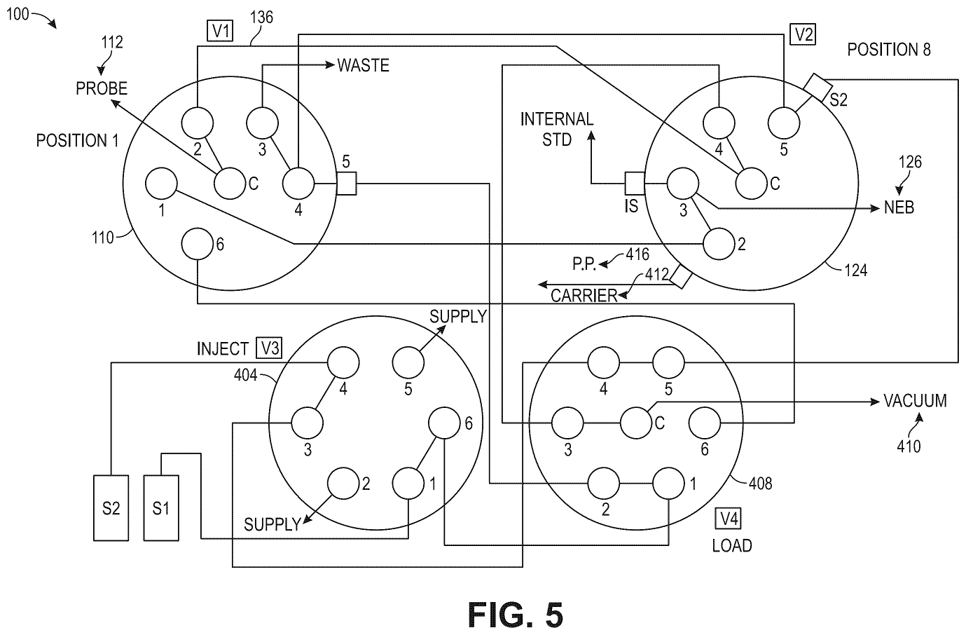

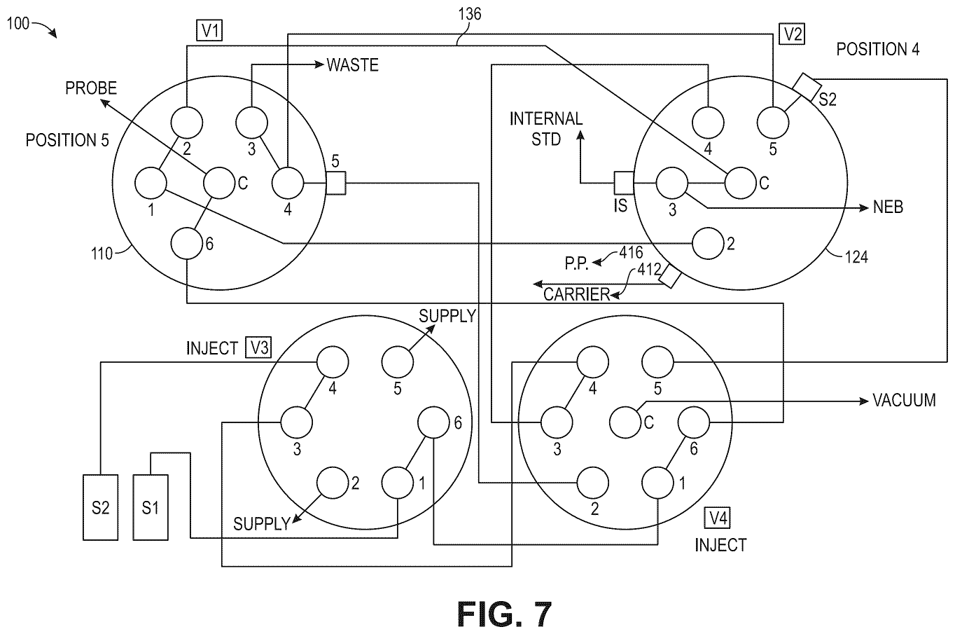

Referring to FIG. 5, the system 100 is shown in an undiluted vacuum load configuration for direct analysis of a fluid sample without dilution. The sample is drawn by the probe 112 into the probe valve 110 via fluid coupling with the vacuum source 410 for transfer to the nebulizer valve 124 via the sample line 136. For example, the vacuum valve 408 fluidically couples the vacuum source 410 with the nebulizer valve 124 which in turn fluidically couples with the probe valve 110 via the sample line 136 to draw the fluid sample through the probe 112, into the probe valve 110, and into the sample line 136 to capture the precise amount of sample within the sample line 136 for subsequent transfer to the nebulizer 126. For instance, as shown in FIG. 7, the probe valve 110 can change configurations to fluidically couple the analytical carrier fluid 412 pushed by the peristaltic pump 416 with the sample line 136 to push the fluid sample held within the sample line 136 to the nebulizer 126 for analysis of the undiluted sample by the analyte detector 128 of the analysis system 104. The nebulizer valve 124 can also fluidically couple the internal standard fluid 414 with the sample line 136 to introduce the internal standard fluid 414 to the undiluted sample within the nebulizer valve 124 (e.g., at port 3) prior to transfer to the nebulizer 126.

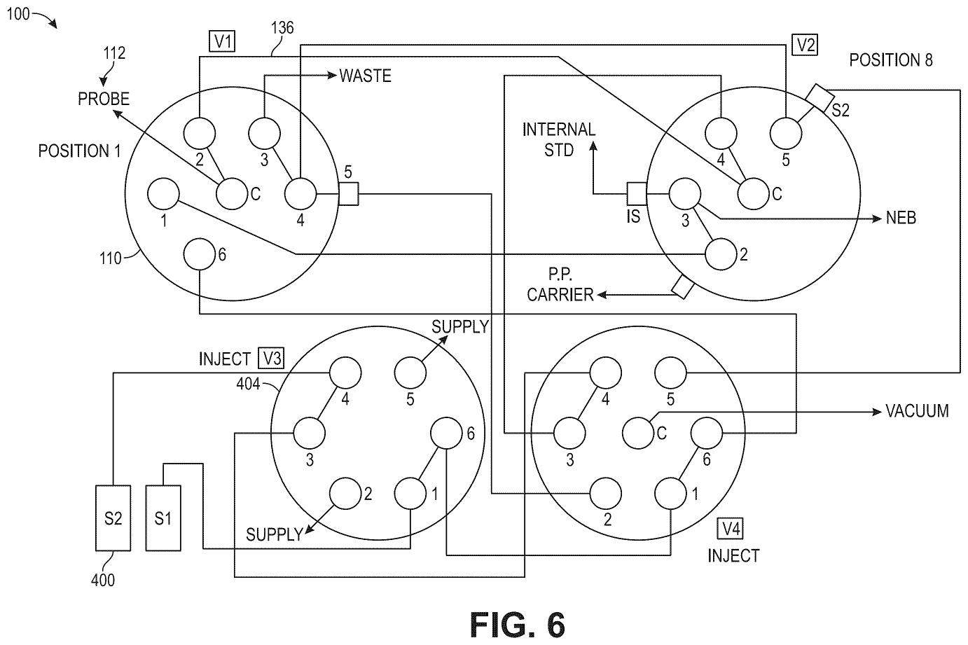

The system 100 can also load the sample line 136 via syringe pump loading. For example, referring to FIG. 6, the system 100 is shown in an undiluted syringe pump load configuration for direct analysis of a fluid sample without dilution. The sample is drawn by the probe 112 into the probe valve 110 via fluid coupling with the syringe pump 400 for transfer to the nebulizer valve 124 via the sample line 136. For example, the pump valve 404 fluidically couples the syringe pump 400 with the probe valve 110 to draw the fluid sample through the probe 112, into the probe valve 110, and into the sample line 136 to capture the precise amount of sample within the sample line 136 for subsequent transfer to the nebulizer 126. For instance, as shown in FIG. 7, the probe valve 110 can change configurations to fluidically couple the analytical carrier fluid 412 pushed by the peristaltic pump 416 with the sample line 136 to push the fluid sample held within the sample line 136 to the nebulizer 126 for analysis of the undiluted sample by the analyte detector 128 of the analysis system 104. The nebulizer valve 124 can also fluidically couple the internal standard fluid 414 with the sample line 136 to introduce the internal standard fluid 414 to the undiluted sample within the nebulizer valve 124 (e.g., at port 3) prior to transfer to the nebulizer 126.

### Diluted Samples

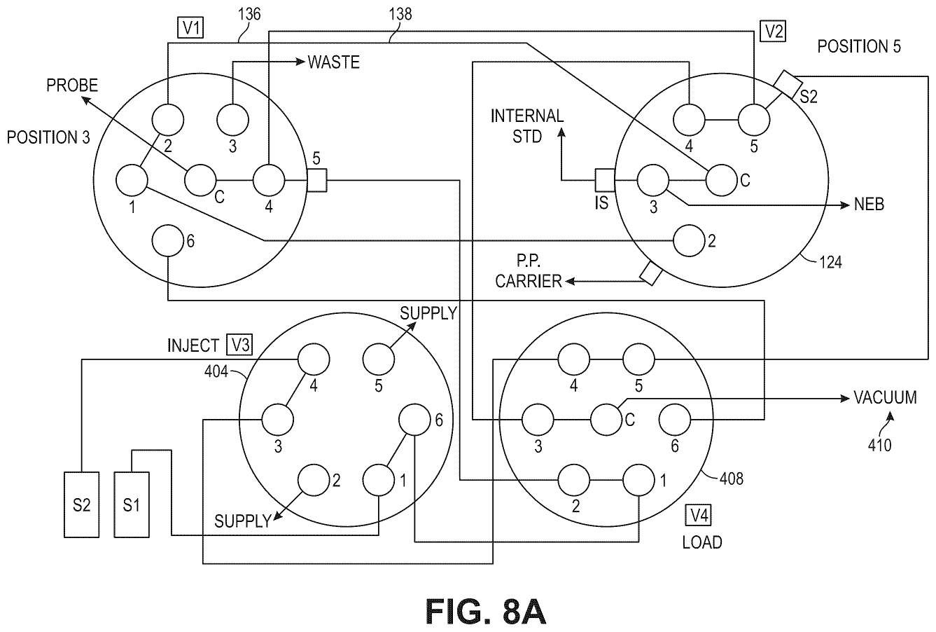

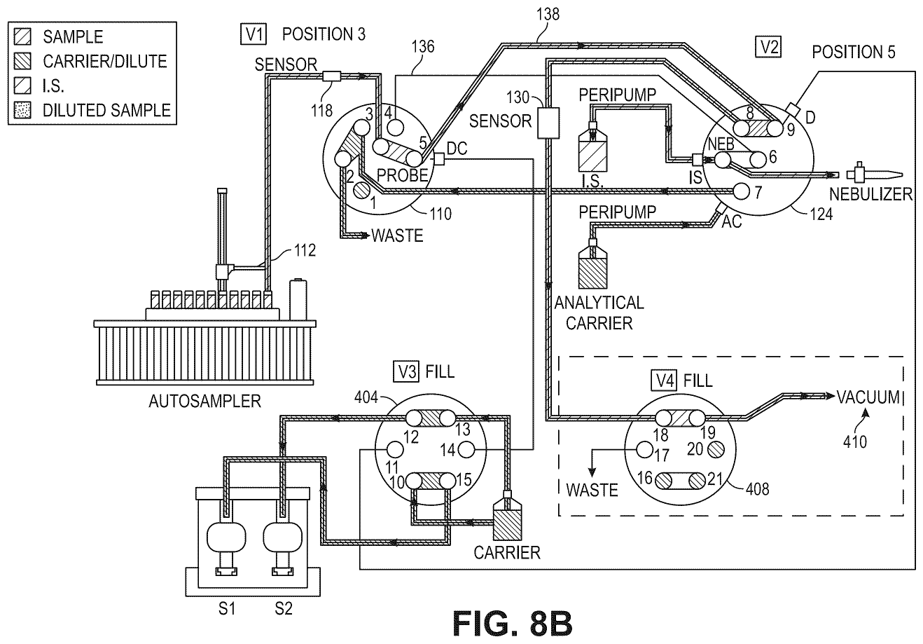

Referring to FIGS. 8A and 8B, the system 100 is shown in a diluted vacuum load configuration for analysis of a fluid sample with a dilution factor exceeding 1 (i.e., a sample to be diluted by inline mixing with a diluent). The sample is drawn by the probe 112 into the probe valve 110 via fluid coupling with the vacuum source 410 for transfer to the nebulizer valve 124 via the dilution line 138. For example, the vacuum valve 408 fluidically couples the vacuum source 410 with the nebulizer valve 124 which in turn fluidically couples with the probe valve 110 via the dilution line 138 to draw the fluid sample through the probe 112, into the probe valve 110, and into the dilution line 138 for subsequent dilution into the sample line 136.

The system 100 can utilize sensors to track the flow of sample through the system 100 to prevent substantial sample overfill into the dilution line (or the sample line 136 for undiluted samples). For example, the system 100 is shown in FIG. 8B including the sensors 118 and 130, which can identify whether liquid or gas is flowing from the probe 112 and into the probe valve 110 (e.g., via sensor 118) and whether liquid or gas is flowing from the nebulizer valve 124 towards the vacuum valve 408 during loading of the sample. The system 100 can utilize data from the sensors 118 and 130 according to a variety of techniques to determine when to deactivate the vacuum source 410 or to decouple fluidic coupling between the nebulizer valve 124 and the vacuum valve 408 (e.g., via switching valve configurations of one or more of the nebulizer valve 124 and the vacuum valve 408) to halt the draw of sample by the sample probe 112. For example, the system 100 can monitor the sensor 130 to determine when the flow of fluid has progressed through the nebulizer valve 124, where upon activation of the sensor 130 indicating the presence of fluid, the system 100 can disengage the vacuum source 410 from the dilution line 138. The sensor 118 can detect the leading edge of the sample as it enters the probe valve 110, which can provide a trigger to begin monitoring the sensor 130 for when the leading edge reaches the sensor 130, indicating that the dilution line 138 is filled with sample.

In implementations, the sensors 118 and 130 can be used to ensure that system fluid lines are empty prior to a new sample being introduced through the sample probe 112. For instance, residual liquid from a previous sample or rinse solution in the system fluid lines (e.g., in the probe 112, the valves (110, 124), the sample line 136, the dilution line 138, etc.) can affect the rate of sampling loading. An empty line will fill faster than a line containing liquid or bubbles. Conventional systems utilize a defined loading time that accounts for both empty system fluid lines and lines that are partially filled with residual fluid or residual fluid with many bubbles. However, this introduces system inefficiencies by potentially utilizing longer load times than necessary, such as if multiple samples are loaded at slower rates than the empty system lines would accommodate. In implementations, the system 100 utilizes the sensors 118 and 130 to verify that the system fluid lines are empty (e.g., through vacuum purge) before the probe 112 is introduced to the next sample at the sample station 114. The system 100 can therefore use a sample load time based on empty fluid lines rather than a longer time that would account for partially filled fluid lines, while also ensuring that the sample is not diluted by interaction with residual fluid within the system fluid lines.

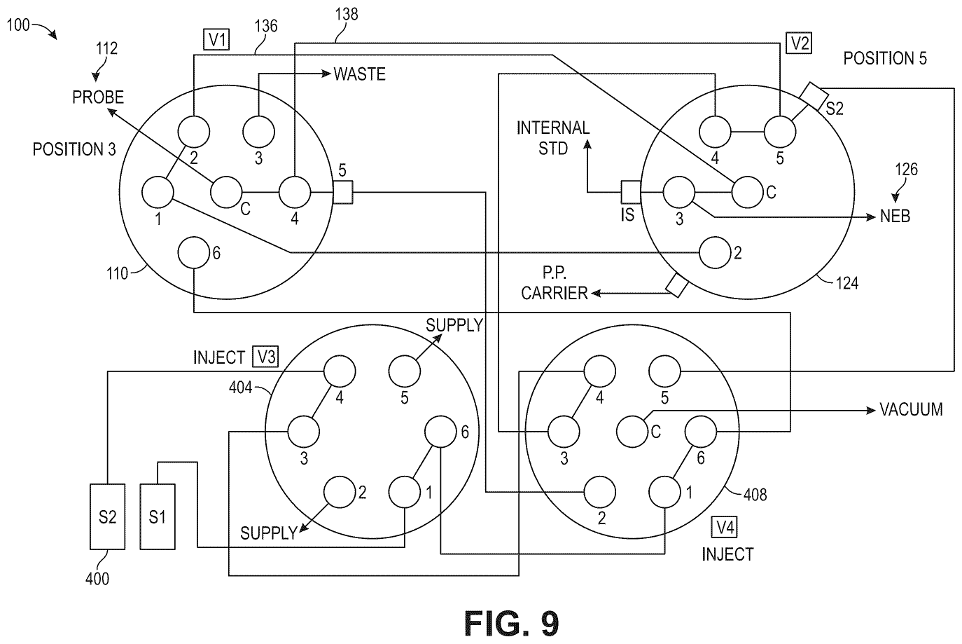

The system 100 can also load the dilution line 138 via syringe pump loading. For example, referring to FIG. 9, the system 100 is shown in a diluted syringe pump load configuration for analysis of a fluid sample with a dilution factor exceeding 1 (i.e., a sample to be diluted by inline mixing with a diluent). The sample is drawn by the probe 112 into the probe valve 110 via fluid coupling with the syringe pump 400 for transfer to the nebulizer valve 124 via the dilution line 138. For example, the pump valve 404 fluidically couples the syringe pump 400 with the vacuum valve 408, which in turn is fluidically coupled with the nebulizer valve 124 to fluidically couple with the probe valve 110 via the dilution line 138 to draw the fluid sample through the probe 112, into the probe valve 110, and into the dilution line 138 for subsequent dilution into the sample line 136.

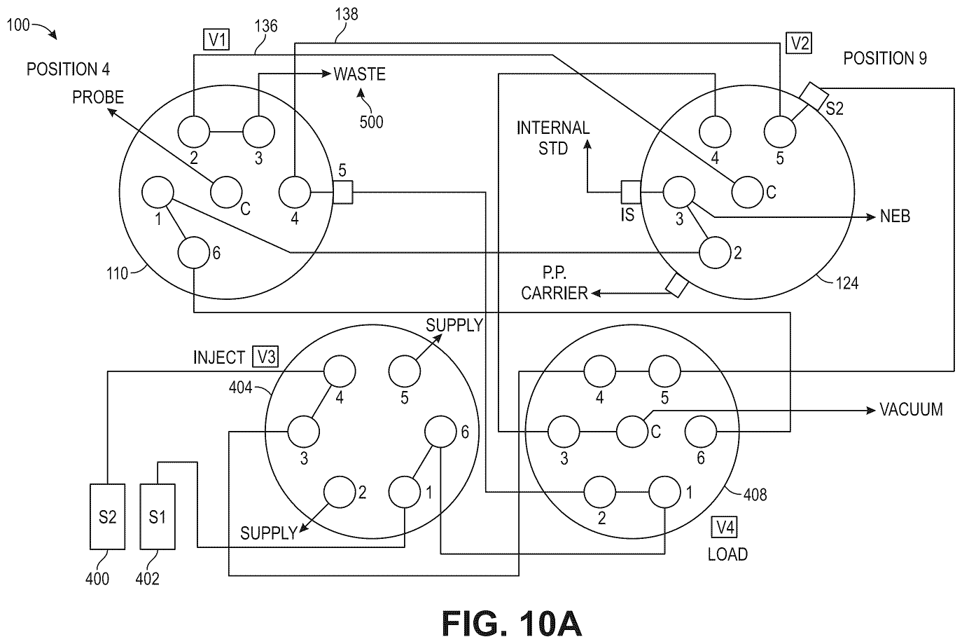

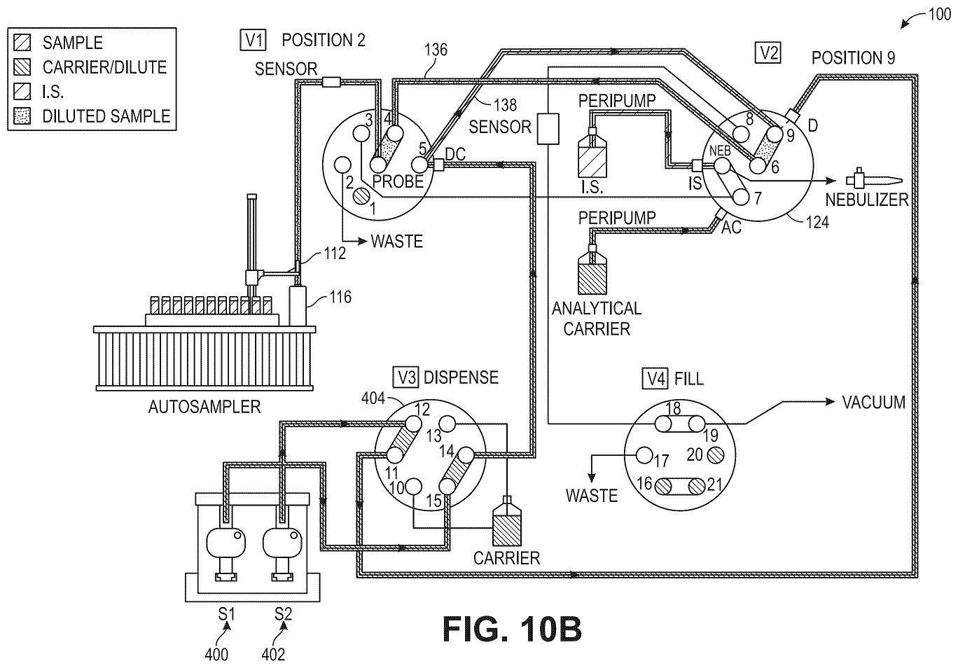

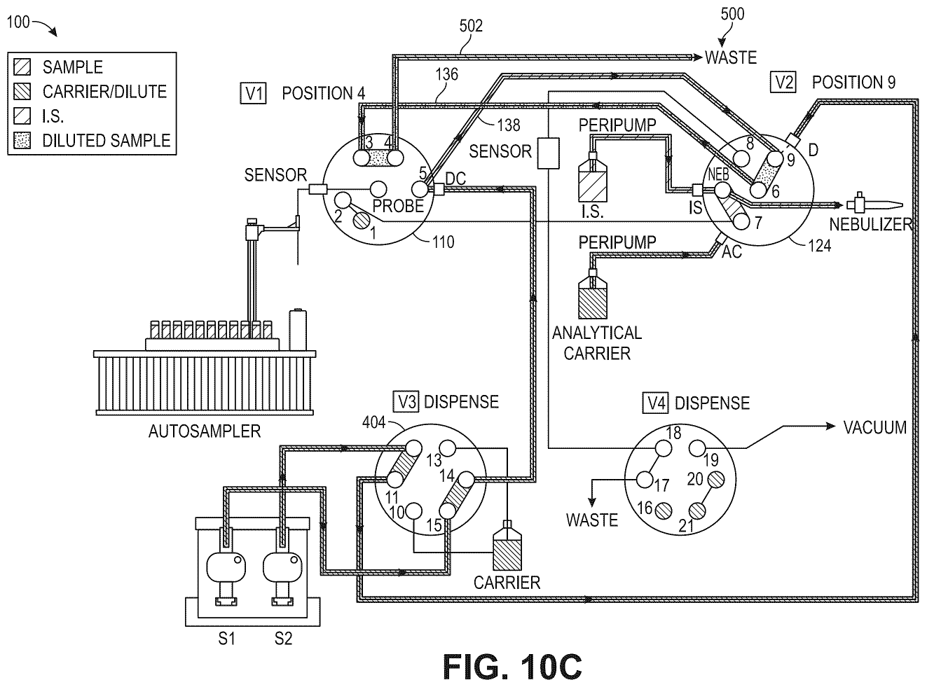

Referring to FIGS. 10A through 10C, the system 100 is shown in configurations to facilitate dilution of the sample held in the dilution line 138, such as by diluting and transferring the fluid sample from the dilution line, into the nebulizer valve 124, and into the sample line 136. The system 100 is shown in FIG. 10A introducing a diluent to the pump valve 404 via the syringe pump 400. The pump valve 404 is fluidically coupled with the vacuum valve 408 and the nebulizer valve 124 to transfer the diluent from the pump valve 404, through the vacuum valve 408, and to the nebulizer valve 124 to mix with the sample (e.g., at port 5 of nebulizer valve 124). For instance, the sample can be pushed from the dilution line 138 via action of the syringe pump 402 which pushes carrier fluid through each of the pump valve 404 and the vacuum valve 408 and into the dilution line 138 to push the sample into the nebulizer valve 124 to combine with the diluent to provide a diluted sample directed by the nebulizer valve 124 into the sample line 136. The system 100 then fills the sample line 136 with diluted sample, with excess diluted sample direct to waste 500.

A factor in the accuracy of sample dilution is the resistance to flow of diluent and sample fluid being diluted, such as provided through backpressure in a dilution line. If the fluids experience variable pressure during introduction of the fluid streams to each other, then the fluids can be introduced at varying flow rates, causing inconsistent dilution factors, or otherwise providing different dilution factors than intended. For sample procedures involving high dilution factors, variability or inconsistency in the flow rates at which the sample and the diluent are introduced to each other can be problematic, leading to erroneous analysis results. For instance, while sample and diluent flow rates can be adjusted relative to each other to provide a desired dilution factor, if the pressure in the dilution line or mixing chamber varies over the course of the dilution process, then the flow rates of the sample and diluent may not be optimal for achieving the desired dilution factor. The system 100 can fluidically couple the dilution line 138 with a defined length of a restriction line having substantially constant volume that exits to atmospheric pressure to carry excess diluted sample away from the dilution line 138 and associated valves. In implementations, the restriction line can be the probe 112 positioned at the rinse station 116 or above the waste outlet 500 or can be an outlet fluid line exiting to atmosphere, as described below with respect to FIGS. 10B and 10C.

Referring to FIG. 10B, the system 100 is shown with the probe 112 facilitating the role as the restriction line during dilution of the sample from the dilution line 138 into the sample line 136, which can also rinse the probe 112, and for probes including a filter (e.g., the filter 122) can backflush the probe to clear particulates held from the filter through the end of the probe 112. For instance, the system 100 is shown with the syringe pump 402 introducing diluent through the pump valve 404 and into the nebulizer valve 124 to be joined with (e.g., at port 5 of the nebulizer valve 124) sample pushed from the dilution line 128 by carrier fluid introduced to the dilution line 128 by the syringe pump 400 through the pump valve 404, into the probe valve 110, and into the dilution line 128. The nebulizer valve 124 directs the diluted sample into the sample line 136 where the probe valve 110 fluidically couples the sample line 136 with the probe 112 to permit excess diluted sample to backflush the probe 112 (e.g., exiting into the rinse station 116). Referring to FIG. 10C, the probe valve 110 instead fluidically couples the sample line 136 with a restriction line 502 instead of the probe 112 to direct excess diluted sample through the restriction line 502 to waste 500 with an exit end of the restriction line 502 exposed to atmospheric pressure. The restriction line (e.g., the probe 112 or the restriction line 502) has a relatively short defined length and constant internal volume to avoid compression of air during dilution or to avoid pressure surges from the flow of bubbles in the restriction line, which would otherwise adversely affect dilution accuracy if the bubbles were within a closed atmospheric fluid line, particularly at high dilution factors.

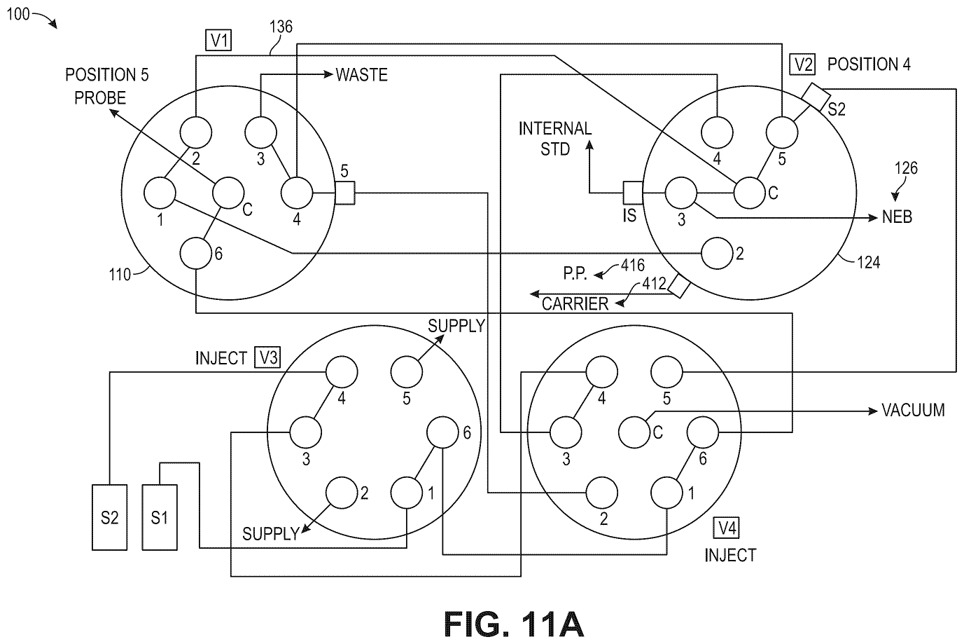

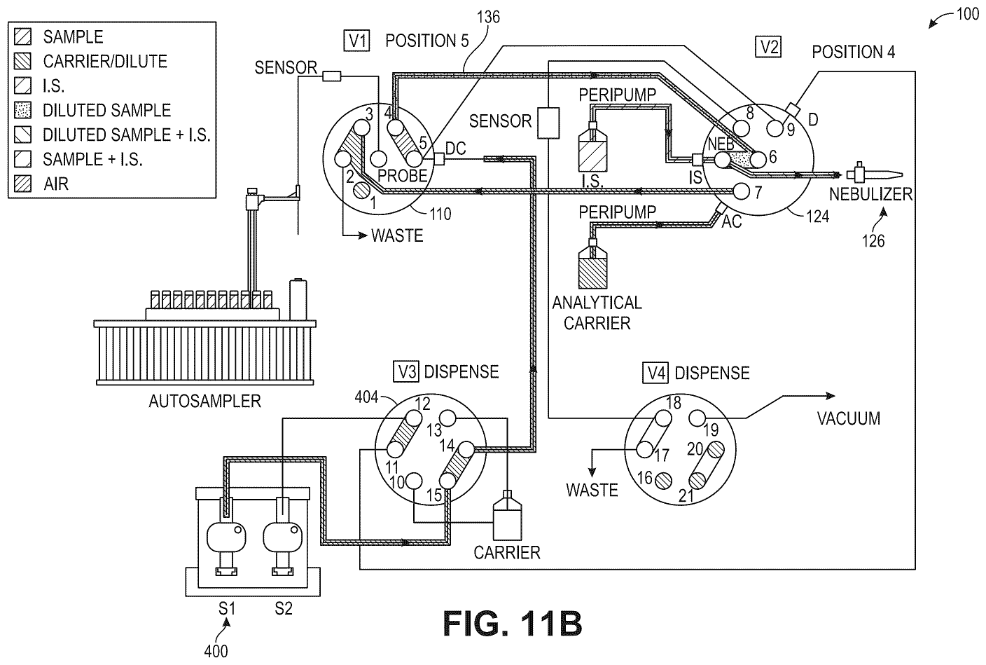

With the diluted sample held in the sample line 136, the system 100 can then proceed to transfer the diluted sample for analysis by the analysis system 104. Referring to FIG. 11A, the system 100 is shown in a dilution inject configuration to transfer the diluted sample from the sample line 136 to the nebulizer 126 via the nebulizer valve 124 for analysis of the diluted sample by the analyte detector 128 of the analysis system 104. For instance, the system 100 can utilize the peristaltic pump 416 to transfer the analytical carrier fluid 412 through the nebulizer valve 124 to the probe valve 110 which directs the carrier fluid 412 into the sample line 136 to push the diluted sample through the nebulizer valve 124 to the nebulizer 126. The system 100 can introduce internal standard fluid 414 to the diluted sample in the nebulizer valve 124 (e.g., via another pump, such as a peristaltic pump, a syringe pump, etc.) during transfer of the diluted sample to the nebulizer 126.

The system 100 can also transfer sample (diluted to undiluted) from the sample line 136 to the nebulizer utilizing a syringe pump to transfer the sample at multiple flow rates to stabilize signal at the analysis system 104. For example, referring to FIG. 11B, the syringe pump 400 facilitates transfer of the sample from the sample line 136 to the nebulizer 126 by pushing carrier fluid through the pump valve 404 and into the probe valve 110 which fluidically couples with the sample line 136 to direct the carrier fluid into the sample line 136 and pushes the sample into the nebulizer valve 124 and into the nebulizer 126. In conventional systems, the flow rate of sample and internal standard is maintained at a constant rate defined by the analytical step at the analysis system 104. Surprisingly, by predispensing the sample into the nebulizer 126 via a syringe pump at a rate from about three times to about ten times higher than the analytical flow rate for a short time and then reducing the sample flow rate to the analytical flow rate for mixing with the internal standard fluid (e.g., introduced via peristaltic pump 416), the sample signal at the analysis system 104 rapidly stabilized, saving five to ten seconds per analysis as compared to a traditional technique where the sample is initially introduced to the nebulizer 126 at the analytical rate with the internal standard. This result is unexpected, since the system 100 transfers the sample for a first time period at a first flow rate that is faster than the analytical flow rate with the internal standard introduced before reducing the speed to a second flow rate (e.g., the analytical flow rate) after the first time period and with the internal standard being introduced for analysis by the analysis system 104, where even with the first flow rate being extra time utilized before analysis, the signal stabilizes much faster upon changing to the analytical rate that five to ten seconds is saved per analysis. Such time savings are significant for overall system throughput, particularly for laboratory environments that process hundreds to thousands of samples daily. In implementations, utilizing a syringe pump for rapid predispensing of the sample at a rate of 3 mL/min and then reducing the flow to 0.3 mL/min at the analytical flow rate achieved a faster signal stabilization than delivering the sample using a constant flow rate of 0.3 mL/min via a peristaltic pump.

### Bubble Separation

In implementations, the system 100 can facilitate the introduction of a gas bubble between two different fluid types in a fluid line to separate the fluids to prevent mixing or dispersion between the different fluid types. In cases where the fluids in contact are of different composition, such as high differences in the levels of dissolved solids or levels of acidity, dilution of the sample into the other fluid can have both volumetric (e.g., flow-determined) and dispersive (e.g., bulk osmotic flow) components, leading to errors in dilution accuracy, especially for the portions of liquid directly in contact. Example dilution events in the system 100 can include bulk osmotic dilution of sample through contact with the analytical carrier fluid 412 after dilution, bulk osmotic dilution of sample through contact with residual rinse solution in fluids lines during dilution, bulk osmotic dilution of sample through contact with the dilution carrier fluid 406 during dilution, or the like.

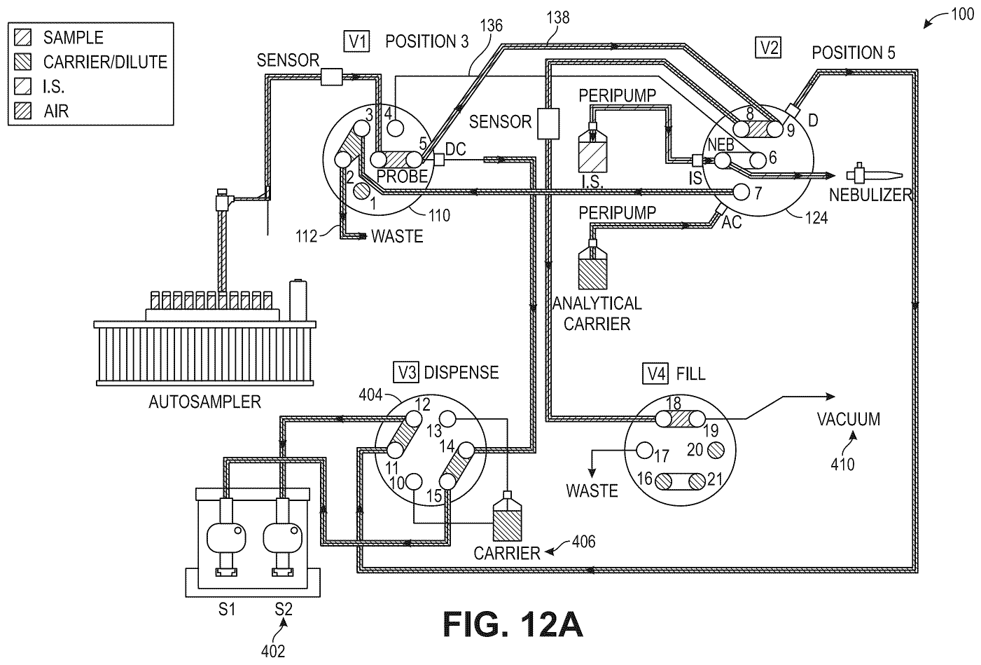

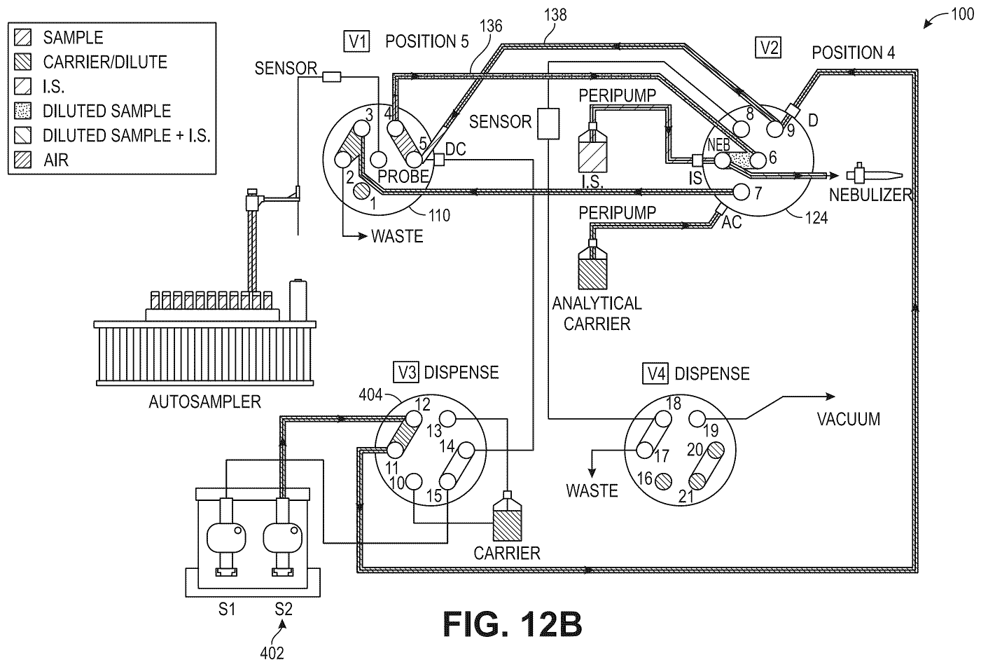

Referring to FIG. 12A, the system 100 is shown in a syringe line bubble introduction configuration to fill a portion of the syringe pump lines with air to prepare to dilute a sample with a first bubble between the fluid sample and the diluent and with a second bubble between the diluted sample and the dilution carrier fluid. For instance, in preparation for dilution techniques, the probe 112 can be exposed to atmosphere and fluidically coupled with each of the syringe pump 400, the syringe pump 402, and the vacuum source 410 to permit each of the syringe pump 400, the syringe pump 402, and the vacuum source 410 to draw air into fluid lines of the system 100 to prevent contact between sample and rinse solution in the sample line 136 and to prevent contact between sample and dilution carrier 406 during dilution into the sample line 136. Alternatively or additionally, the system 100 can include one or more pressurized gas sources to inject gas into the fluid flow path of the diluted sample to provide the bubbles described herein.

In implementations, the bubble introduction techniques during dilution can be utilized for sample dilutions involving low dilution factors that require more sample held in the dilution line 138 between the nebulizer valve 124 and the probe valve 110 to be used during dilution as compared to higher dilution factors that utilize far more diluent than sample, utilizing less sample held in the dilution line 138 to prepare the diluted sample. For example, the system 100 can be controlled (e.g., via control system 108) to introduce the first bubble between the leading edge of sample and rinse solution in the sample line 136 and the second bubble between the trailing edge of sample and the leading edge of dilution carrier 406 when the sample to be analyzed by the analysis system 104 is configured to have a dilution factor of from greater than 1× to 10×. For sample preparations involving dilution factors greater than 10×, the dilution line 138 can include sufficient amounts of sample available for dilution such that the time taken to introduce the bubbles into the system fluid lines can be avoided. For instance, the system 100 can be controlled (e.g., via control system 108) to prevent the introduction of the first bubble and the second bubble described above when the sample to be analyzed by the analysis system 104 is configured to have a dilution factor of more than 10×.

In implementations, an example of which is shown in FIG. 12B, the system 100 introduces a gas bubble into the sample line 136 between a trailing edge of the diluted sample and a leading edge of the analytical carrier fluid 412 to prevent physical contact between the diluted sample and the carrier fluid through the presence of the buffer bubble. For instance, the system 100 can draw a gas into a channel of the probe valve 110 (e.g., subsequent to a filter backflush operation) prior to transfer of a diluted sample from the sample line 136 to the nebulizer 126 via the nebulizer valve 124. The probe valve 110 can then introduce the channel into a flow path between the diluted sample and the incoming carrier fluid 406 (e.g., pump by syringe pump 402) used to push the diluted sample from the sample line 136 to cause the carrier fluid to push the gas in the channel, or a portion thereof, into the sample line 136 behind the diluted sample. The bubble prevents contact between the diluted sample and the carrier fluid 406, which in turn prevents mixing of a portion of the trailing end of the diluted sample with a portion of the leading end of the carrier fluid 406 due to internal fluid line fluid dynamics (e.g., where fluid closer to the internal walls of the fluid line travels through the fluid line more slowly than fluid towards the center of the fluid line due to friction of the internal walls and fluid dynamics of faster fluid passing slower fluid) and/or due to the bulk osmotic dilution effect.

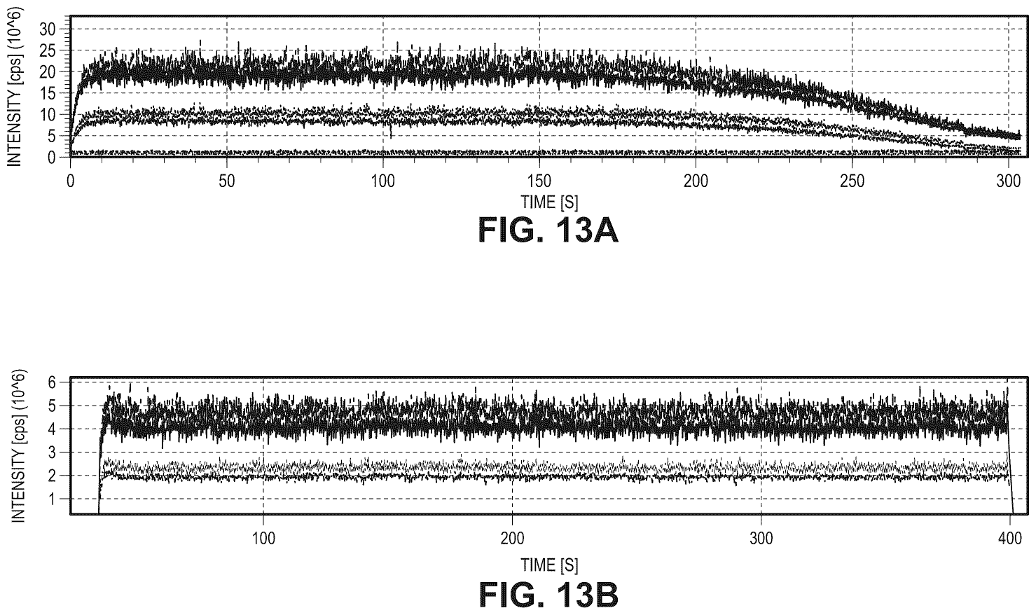

The bubble can prevent signal wash out of analytes present towards the end of the sample stream sent to the analysis system 104, where such analytes could otherwise be mixed with carrier fluid. For example, FIG. 13A shows a dataset corresponding to analysis of a fluid sample transferred through the sample line 136 of the system 100 via a carrier fluid with direct contact between the carrier fluid and an end of the fluid sample in the sample line 136. The dataset shows a trailing portion beginning at approximately 150 seconds where the concentration of multiple analytes begins to lessen gradually over time as the carrier fluid mixes with the analytes. The trailing portion shows a dilution of the sample by the carrier fluid and does not represent an accurate amount of analytes in the sample, thus providing a significant amount of time that no useful data is generated (e.g., from 150 seconds to 300 seconds and above).

Referring to FIG. 13B, a dataset is shown corresponding to analysis of a fluid sample transferred through the sample line 136 of the system 100 via a carrier fluid with a gas bubble interposed between the end of the fluid sample and the carrier fluid, preventing direct contact between the carrier fluid and the fluid sample in the sample line. The dataset of FIG. 13B shows that the analyte concentration is substantially continuous, without the trailing concentration trend shown in FIG. 13A. As a result, presence of the bubble facilitates a longer duration of generating useful sample data since the dataset of FIG. 13B corresponds to sample that is not diluted by the carrier fluid, while also avoiding the duration of non-useful data that is caused by mixing of the carrier fluid and the sample (e.g., providing efficient use of system resources, such as time and materials that are not wasted by generating data that does not correspond to the sample).

### Sample Filtration

The system can include a filter probe including a filter disposed between the probe and the fluid line into which the probe draws sample fluids to capture particulates with the filter that could potentially clog system components, such as fluid lines, valves, and the like. Referring to FIG. 14, an example filter probe 112 is shown generally including a probe tube 1400, a probe connector 1402, the filter 122, a fluid line connector 1404, and a fluid line 1406. The filter 122 is disposed between the probe tube 1400 and the fluid line 1406 to capture particulates from sample fluid drawn into the probe tube 1400 (e.g., via action by a pump (e.g., syringe pump 400, 402), a vacuum source (e.g., vacuum source 410), or the like) while permitting fluid to pass through the filter 122 to the fluid line 1406 for further handling by the system 100. The probe connector 1402 couples the probe tube 1400 with the filter 122, whereas the fluid line connector 1404 couples the fluid line 1406 with the filter 122 to provide a continuous fluid flow pathway from the probe tube 1400 to the fluid line 1406. While the filter 122 is shown as a female to male connector having screw type connections with the probe connector 1402 and the fluid line connector 1404, the filter 122 is not limited to such configuration and can include alternative connection configurations, such as female to female connectors, male to male connectors, snap fit connections, press fit connections, and the like, and combinations thereof, without departing from the scope of the present disclosure.

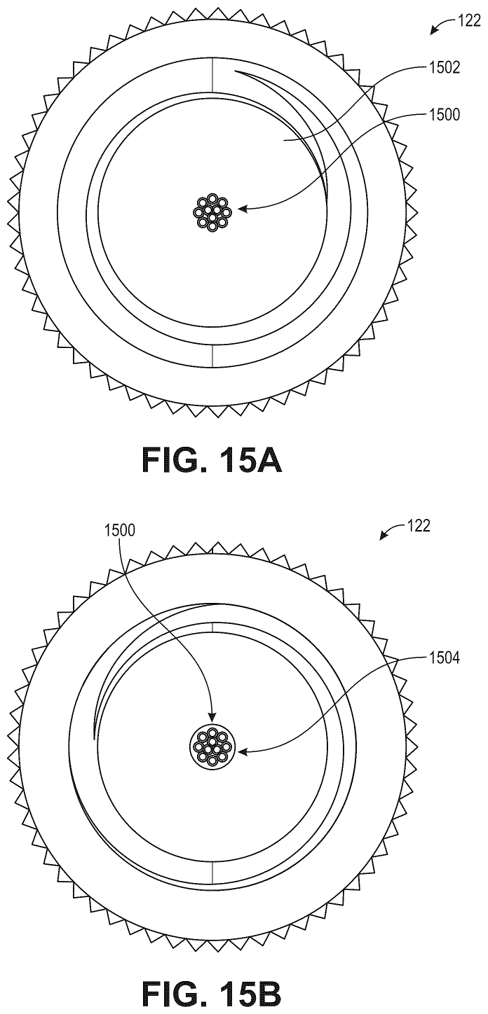

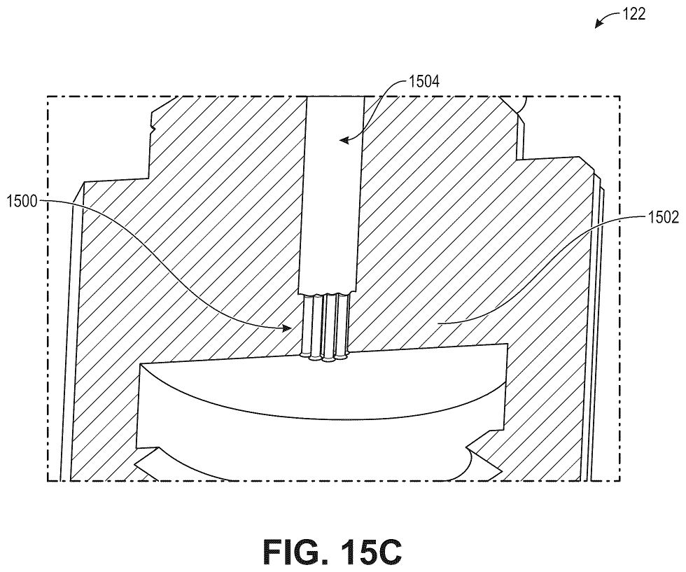

Referring to FIGS. 15A through 15C, an example of the filter 122 is shown in accordance with an example embodiment of the present disclosure. The filter 122 is shown as a single piece construction filter without substantive dead space encountered by fluid during backflushing of fluids through the probe 112 (e.g., described with reference to FIG. 10B), such as by introducing fluid from the fluid line 1406, through the filter 122, and into the probe tube 1400, which allows the system to backflush fluid back through the filter 122 to remove particulates caught by the filter 122 from previous sample drawn through the probe 112. In implementations, the single piece construction provides for a solid filter 122 without ultrasonic welding or other technique to join the filter body with fittings used to couple the filter body 1502 with the fluid line 1406 and the probe tube 1400. For instance, the filter 122 includes an array of through-holes 1500 extending through a filter body 1502. The through-holes 1500 extend through the filter body 1502 in a flow direction of fluid through the filter 122 to permit fluid to flow from the probe tube 1400 into the filter 122, through the through-holes 1500, and into the fluid line 1406. The through-holes 1500 are sized according to a desired size of particulate to be filtered from the sample fluid, with particulates larger than a given through-hole 1500 being blocked by the filter body 1502 and prevented from passing through the through-holes 1500. In implementations, the through-holes 1500 are formed by drilling through the filter body 1502.

The filter 122 can include the array of through-holes 1500 that are arranged entirely within a cross-sectional area of the fluid line 1406 coupled with the filter 122, which allows the system 122 to backflush the entire filter 122 in a single pass of fluid. For instance, the through-holes 1500 are arranged entirely within the flow path of fluid passed through the fluid line 1406 coupled with the filter opposite the probe. For example, the filter 122 can define a flow passage 1504 that intersects with the array of through-holes 1500 where the cross-section of the flow passage 1504 perpendicular to the direction of fluid flow substantially matches the cross-section of the fluid line 1406, such that the array of through-holes 1500 is positioned entirely within the cross-section of the flow passage 1504 to arrange the array of through-holes 1500 entirely within the cross-sectional area of the fluid line 1406.

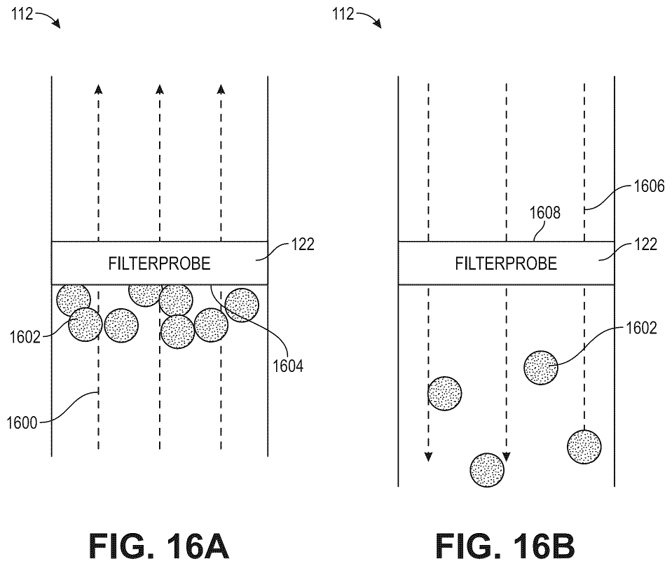

The filter probe 112 is shown in FIGS. 16A and 16B, where the filter probe 112 draws sample fluid 1600 including particulates 1602 through the filter 122, trapping the particulates 1602 on a bottom side 1604 of the filter 122 (e.g., against the filter body 1502), allowing the sample fluid 1600 to pass through without the associated particulates 1602. The system 100 can then backflush the filter probe 122, such as shown in FIG. 16B, where backflush fluid 1606 is introduced to a top side 1608 of the filter 122, which passes through the filter 122 to interact with and dislodge the particulates 1602 from the bottom side 1604 of the filter 122 to pass out of the filter probe 122. For instance, the system 100 can position the probe 112 at the rinse station 116 and introduce a rinse solution, carrier fluid, or the like, into the probe 112 to push particulates captured by the filter 122 out from the end of the probe 112 and into the rinse station 116. In implementations, the backflush fluid is a pressurized fluid to prevent accumulation of particulates within the probe 112, prevent the memory effect of chemical analysis influenced by particulates within the probe 112, or combinations thereof.

### Valve Displays and Sensors

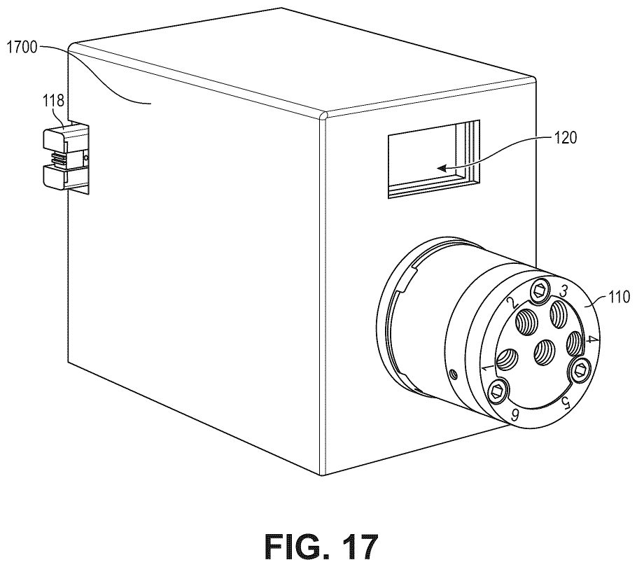

The system 100 can include the displays 120 and 132 and the sensors 118 and 130 to provide various operational information for the system 100 and the components thereof. For example, referring to FIG. 17, an example display 120 of the probe valve 110 is shown. The displays 120 and 132 can be coordinated with the control system 108 to display independent messages to each of the probe valve 110 and the nebulizer valve 124 to provide real-time system updates for each valve. In implementations, the messages shown on the screens include custom messages assigned to the respective displays 120 and 132 when the respective valve is in a particular configuration, such as those shown in FIGS. 4A through 12B. As such, the system 100 can display real-time system messaging on each display, while facilitating the option for displaying different messages at each valve.

The sensors 118 and 130 can include sensors (e.g., optical sensors, ultrasonic sensors, pressure transducers, etc.) to sense the presence or absence of fluid flowing through fluid lines of the system 100. For example, the sensors 118 and 130 can be used to determine that one or more of the sample line 136, the dilution line 138, or additional fluid lines 140 is filled with fluid (e.g., without substantive amounts of bubbles), or to note the presence of bubbles or voids within the fluid lines. For example, the sensor 118 can be positioned on or adjacent the probe valve 110 and the sensor 130 can be positioned on or adjacent the nebulizer valve 124 to measure the fluid flowing through the sample line 136, through one or more diluent lines 136, 138, or combinations thereof. The sensors 118 and 130 can be removably mounted to a housing 1700 of a sensor module (e.g., shown in FIG. 17), for example, by being detachable with a cable (e.g., retractable, coiled, spooled, etc.) to permit remote sensing of different fluid lines of the system.

### Carrier Flow

In implementations, the system 100 is configured to facilitate introduction of carrier fluid between the probe valve 110 and the nebulizer valve 124 to maintain the passage of carrier flow to the nebulizer 126 of the analysis system 104 during sample loading and sample dilution. For example, the system 100 can include a carrier flow source having a tee or valve line where the probe valve 110 or the nebulizer valve 124 blocks the supply of carrier fluid to one valve or the other valve while allowing a substantially continuous flow of liquid to the nebulizer 124. Used herein, “substantially continuous” refers to continuous supply of liquid with minute disruptions in the flow of flow caused by changing configurations of the valves of the system, and functional equivalents thereof.

Electromechanical devices (e.g., electrical motors, servos, actuators, or the like) may be coupled with or embedded within components of the system 100 (e.g., the valves, the syringe pumps, and combinations thereof) to facilitate automated operation via control logic embedded within or externally driving the system 100, coordinated by the control system 108. The electromechanical devices can be configured to cause the plurality of valves to direct fluid flows from syringes, valves, flow paths, etc., according to one or more modes of operation, such as those described herein. The system 100 may include or be controlled by a computing system having a processor configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the probe 112 (or corresponding autosampler system 102), syringe pumps, and any of the various pumps or selection valves described herein. The program instructions, when executing by the processor, can cause the computing system to control the system 100 (e.g., control the pumps and selection valves) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

Furthermore, it is to be understood that the invention is defined by the appended claims. Although embodiments of this invention have been illustrated, it is apparent that various modifications may be made by those skilled in the art without departing from the scope and spirit of the disclosure.

What is claimed is:

1. An autodilution system to prepare samples containing one or more analytes of interest for analysis, comprising:
a probe valve fluidically coupled with a sample probe to receive a fluid sample from the sample probe;
a nebulizer valve configured to fluidically couple with a nebulizer of an analysis system;
a plurality of fluid lines fluidically coupling the probe valve with the nebulizer valve, the plurality of fluid lines including (i) a sample line having a known and predefined internal volume from the probe valve to the nebulizer valve and (ii) a dilution line, into which a sample to be diluted is directed prior to transfer to the sample line;
a pump system configured to transfer fluids through the probe valve, the nebulizer valve, and the plurality of fluid lines; and
a controller operably coupled with each of the probe valve and the nebulizer valve, the controller configured to access sample information associated with the fluid sample to determine a dilution factor for the fluid sample, the controller further configured to change the configuration of one or more of the probe valve or the nebulizer valve based on the dilution factor assigned to the fluid sample to direct, via action of the pump system, the fluid sample into the dilution line prior to the sample line for fluid samples having a dilution factor greater than one.

2. The autodilution system of claim 1, wherein the pump system includes at least one of a syringe pump or a vacuum source to draw the fluid sample into the sample probe.

3. The autodilution system of claim 1, wherein the control system is configured to control the pump system to draw the fluid sample from the sample probe, through the probe valve, and into the sample line for the dilution factor being one.

4. The autodilution system of claim 1, wherein the control system is configured to control the pump system to draw the fluid sample from the sample probe, through the probe valve, and into the dilution line for the dilution factor being greater than one.

5. The autodilution system of claim 4, wherein the pump system is configured to push the fluid sample from the dilution line to the nebulizer valve via a dilution carrier fluid and simultaneously introduce a diluent to the nebulizer valve to mix with the fluid sample and provide a diluted sample, wherein the pump system is configured to push the diluted sample from the nebulizer valve into the sample line.

6. The autodilution system of claim 5, wherein the pump system is configured to selectively introduce at least one of a first bubble in front of the fluid sample prior to pushing the fluid sample from the dilution line to the nebulizer valve and a second bubble behind the fluid sample prior to pushing the fluid sample from the dilution line to the nebulizer valve to separate the fluid sample from the dilution carrier fluid.

7. The autodilution system of claim 6, wherein the controller is configured to control the pump system to selectively introduce the at least one of the first bubble or the second bubble only for the dilution factor being from greater than 1× to 10×.

8. The autodilution system of claim 5, wherein the pump system is configured to push the diluted sample via an analytical carrier fluid from the sample line, through the nebulizer valve, and to the nebulizer for analysis of the diluted sample.

9. The autodilution system of claim 8, wherein the pump system is configured to introduce a bubble behind the diluted sample prior to pushing the diluted sample from the sample line to the nebulizer valve to separate the diluted sample from the analytical carrier fluid.

10. The autodilution system of claim 8, wherein the pump system is configured to introduce an internal standard fluid to the nebulizer valve to mix with the diluted sample pushed from the sample line.

11. The autodilution system of claim 10, wherein the controller is configured to control the pump system to push, for a first time period and at a first flow rate, the diluted sample via the analytical carrier fluid from the sample line, through the nebulizer valve, and to the nebulizer without introducing the internal standard fluid to the nebulizer valve, and to control the pump system to push, following expiration of the first time period and at a second flow rate, the diluted sample via the analytical carrier fluid from the sample line, through the nebulizer valve, and to the nebulizer simultaneously with introducing the internal standard fluid to the nebulizer valve, wherein the first flow rate is greater than the second flow rate.

12. The autodilution system of claim 11, wherein the first flow rate is from three times to ten times greater than the second flow rate.

13. A method to prepare samples containing one or more analytes of interest for analysis, comprising:
drawing a fluid sample from a sample vessel into a sample probe of an autodilution system, the autodilution system including:
a probe valve fluidically coupled with the sample probe to receive the fluid sample from the sample probe,
a nebulizer valve configured to fluidically couple with a nebulizer of an analysis system,
a plurality of fluid lines fluidically coupling the probe valve with the nebulizer valve, the plurality of fluid lines including (i) a sample line having a known and predefined internal volume from the probe valve to the nebulizer valve and (ii) a dilution line, into which a sample to be diluted is directed prior to transfer to the sample line,
a pump system configured to transfer fluids through the probe valve, the nebulizer valve, and the plurality of fluid lines, and
a controller operably coupled with each of the probe valve and the nebulizer valve, the controller configured to access sample information associated with the fluid sample to determine a dilution factor for the fluid sample, the controller further configured to change the configuration of one or more of the probe valve or the nebulizer valve based on the dilution factor assigned to the fluid sample to direct, via action of the pump system, the fluid sample into dilution line prior to the sample line for fluid samples having a dilution factor greater than one;
transferring, via the pump system, the fluid sample from the sample probe, through the probe valve, and into the sample line for the dilution factor being one; and
transferring, via the pump system, the fluid sample from the sample probe, through the probe valve, and into the dilution line for the dilution factor being greater than one.

14. The method of claim 13, further comprising:
pushing, via the pump system, the fluid sample from the dilution line to the nebulizer valve with a dilution carrier fluid and simultaneously introducing, via the pump system, a diluent to the nebulizer valve to mix with the fluid sample and provide a diluted sample; and
pushing, via the pump system, the diluted sample from the nebulizer valve into the sample line.

15. The method of claim 14, further comprising selectively introducing at least one of a first bubble in front of the fluid sample prior to pushing the fluid sample from the dilution line to the nebulizer valve and a second bubble behind the fluid sample prior to pushing the fluid sample from the dilution line to the nebulizer valve to separate the fluid sample from the dilution carrier fluid.

16. The method of claim 15, wherein selectively introducing at least one of the first bubble or the second bubble includes selectively introducing at least one of the first bubble or the second bubble only for the dilution factor being from greater than 1× to 10×.

17. The method of claim 14, further comprising pushing, via the pump system, the diluted sample via an analytical carrier fluid from the sample line, through the nebulizer valve, and to the nebulizer for analysis of the diluted sample.

18. The method of claim 17, further comprising introducing a bubble behind the diluted sample prior to pushing the diluted sample from the sample line to the nebulizer valve to separate the diluted sample from the analytical carrier fluid.

19. The method of claim 17, further comprising introducing, via the pump system, an internal standard fluid to the nebulizer valve to mix with the diluted sample pushed from the sample line.

20. The method of claim 19, further comprising:
pushing for a first time period and at a first flow rate, via the pump system, the diluted sample with the analytical carrier fluid from the sample line, through the nebulizer valve, and to the nebulizer without introducing the internal standard fluid to the nebulizer valve, and
following expiration of the first time period, pushing, via the pump system, the diluted sample with the analytical carrier fluid at a second flow rate from the sample line, through the nebulizer valve, and to the nebulizer simultaneously with introducing the internal standard fluid to the nebulizer valve, wherein the first flow rate is greater than the second flow rate.
